(19) United States
(12) Patent Application Publication
(10) Pub. No.: US 2022/0103638 A1
(43) Pub. Date: Mar. 31, 2022

(54) LPWAN SYSTEM WITH HYBRID ARCHITECTURE

(71) Applicant: Multi-Tech Systems, Inc., Mounds View, MN (US)

(72) Inventors: Prasad V. KANDIKONDA, Plymouth, MN (US); Jason Scott REISS, Saint Michael, MN (US); Michael B. NICHOLSON, Minneapolis, MN (US)

(73) Assignee: Multi-Tech Systems, Inc., Mounds View, MN (US)

(21) Appl. No.: 17/420,544

(22) PCT Filed: Jan. 7, 2020
(86) PCT No.: PCT/US2020/012532

§ 371 Date: Jul. 2, 2021

Related U.S. Application Data
(60) Provisional application No. 62/789,028, filed on Jan. 7, 2019.

(51) Int. Cl. H04L 67/125; H04L 67/1031; H04L 67/1014; H04L 41/082

(52) U.S. Cl. CPC H04L 67/125; H04L 41/082; H04L 67/1014; H04L 67/1031

(57) ABSTRACT

A network system includes a cloud server, and a gateway host coupled to the cloud server. The gateway host includes an application server to execute an application. The network system includes a plurality of end devices. Each end device is configured to wirelessly send and receive communication signals to and from the gateway host. The gateway host is configured to receive sensed data from the plurality of end devices, process the received sensed data with the application, and communicate results of the processing to the cloud server.

### BACKGROUND

In certain network applications, such as Low Power Wide Area Network (LPWAN) applications, signals are transmitted between end devices (e.g., sensor devices) and gateway devices according to established protocols. In a typical LPWAN implementation, gateway devices receive raw data from end devices and then forward that raw data to a cloud server for processing. Thus, all received data is forwarded to the cloud, with no processing or business logic being applied to the data at the gateway level.

### SUMMARY

A network system includes a cloud server, and a gateway host coupled to the cloud server. The gateway host includes an application server to execute an application. The network system includes a plurality of end devices. Each end device is configured to wirelessly send and receive communication signals to and from the gateway host. The gateway host is configured to receive sensed data from the plurality of end devices, process the received sensed data with the application, and communicate results of the processing to the cloud server.

### BRIEF DESCRIPTION OF THE DRAWINGS

FIG. 1 is a block diagram illustrating a Low Power Wide Area Network (LPWAN) system in accordance with one embodiment.

FIG. 2 is a block diagram illustrating a computing system for implementing elements of the system shown in FIG. 1 in accordance with one embodiment.

FIG. 3 is a block diagram illustrating a network system in accordance with one embodiment.

FIG. 4 is a block diagram illustrating an LPWAN system in accordance with another embodiment.

FIG. 5 is a flow diagram illustrating a method in a network system in accordance with one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that the features of the various exemplary embodiments described herein may be combined with each other, unless specifically noted otherwise.

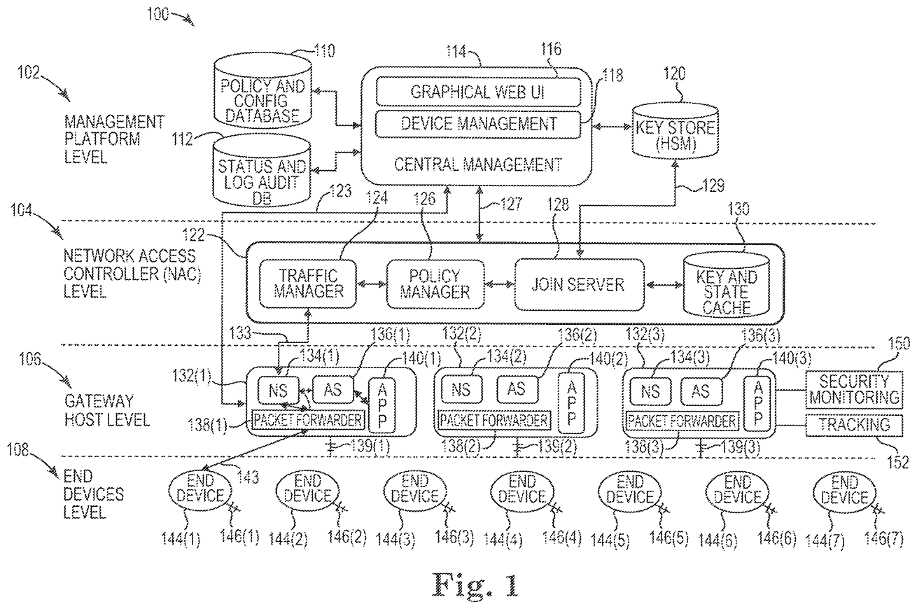

FIG. 1 is a block diagram illustrating a Low Power Wide Area Network (LPWAN) system 100 in accordance with one embodiment. In one embodiment, LPWAN system 100 has a LoRa® or LoraWAN™ system configuration. The architecture of LPWAN system 100 may be referred to as a “star-of-stars” topology. LPWAN system 100 includes management platform level 102, network access controller (NAC) level 104, gateway host level 106, and end devices level 108. The management platform level 102 includes policy and configuration database 110, status and log audit database 112, central management controller 114, and key store 120. In one embodiment, the key store 120 comprises a hardware security module (HSM) computing device that stores digital keys for the LPWAN system 100. In another embodiment, the key store 120 may comprise another type of storage unit. The central management controller 114 includes graphical web user interface (UI) 116 and device management controller 118. In one embodiment, central management controller 114 comprises a cloud server. The number of elements shown at each of the levels 102, 104, 106, and 108 may vary from the number shown in FIG. 1.

The NAC level 104 includes a network access controller 122. The network access controller 122 includes traffic manager 124, policy manager 126, join server 128, and key and state cache 130. The network access controller 122 is communicatively coupled to the central management controller 114 via communication link 127.

The gateway host level 106 includes a plurality of gateway hosts 132(1)-132(3) (collectively referred to as gateway hosts 132). The gateway host 132(1) includes network server (NS) 134(1), application server (AS) 136(1), packet forwarder 138(1), and application (App) 140(1). The gateway host 132(2) includes network server 134(2), application server 136(2), packet forwarder 138(2), and application 140(2). The gateway host 132(3) includes network server 134(3), application server 136(3), packet forwarder 138(3), and application 140(3). Network servers 134(1)-134(3) may collectively be referred to as network servers 134. Application servers 136(1)-136(3) may collectively be referred to as application servers 136. Packet forwarders 138(1)-138(3) may collectively be referred to as packet forwarders 138. Applications 140(1)-140(3) may collectively be referred to as applications 140. Each gateway host 132 may be connected to central management controller 114 via standard internet protocol (IP) connections 123. In one embodiment, gateway hosts 132 are implemented with edge computing resources, and central management controller 114 is implemented with cloud computing resources.

The end devices level 108 includes a plurality of end devices 144(1)-144(7) (collectively referred to as end devices 144). In one embodiment, the end devices 144 are sensors. In one embodiment, end devices 144 are battery-operated devices, such as battery-operated sensors, intended for low power operation in order to maximize battery life, while at the same time allowing for substantial wireless transmission distance between end devices 144 and gateway hosts 132.

In one embodiment, gateway hosts 132(1)-132(3) respectively include antennas 139(1)-139(3) (collectively referred to as antennas 139); and end devices 144(1)-144(7) respectively include antennas 146(1)-146(7) (collectively referred to as antennas 146). The antennas 139 and 146 allow wireless communications 143 between the end devices 144 and the gateway hosts 132. Each of the end devices 144 may use single-hop wireless communication to one or many of the gateway hosts 132. In one embodiment, end device communications are bidirectional, such that each gateway host 132 both transmits communication signals to, and receives signals from, one or more end devices 144 via one of the gateway antennas 139. Similarly, each end device 144 both transmits communication signals to, and receives signals from, one or more gateway hosts 132 via one of the end device antennas 146.

Communication signals between end devices 144 and gateway hosts 132 may be spread out on different frequency channels and data rates. The selection of the data rate is a trade-off between communication range and message duration. Due to the spread spectrum technology, communication signals with different data rates do not interfere with each other, and instead create a set of “virtual” channels, increasing the capacity of the gateway hosts 132. In one embodiment, LPWAN system 100 uses data rates that range from 0.3 kbps to 50 kbps. In order to maximize both battery life of end devices 144 and overall network capacity, the network servers 134 may manage the data rate and RF output for each end device 144 individually by means of an adaptive data rate (ADR) scheme.

In one embodiment, the gateway hosts 132, the network access controller 122, and the central management controller 114 are all separate appliances that may be positioned at different locations. For example, assume that the system 100 is used by a restaurant chain, and that the end devices 144 are sensors for detecting when a soap dispenser button has been pushed. This information may be used by system 100 to monitor soap usage by employees and/or determine when particular soap dispensers need to be refilled. In this example, one or more of the end devices 144 may be positioned in a restroom of the restaurant; a gateway host 106 may be positioned in a back room of the restaurant; the network access controller 122 may be positioned in a different room of the restaurant or at a location remote from the restaurant; and the central management controller 118 may be positioned at a remote cloud server location. Other restaurants in the chain may be configured in a similar manner. If system 100 is implemented in a large enterprise, the system may include, for example, millions of end devices 144, thousands of gateway hosts 132, hundreds of network access controllers 122, and one (or a small number) of central management controllers 114. In other embodiments, a gateway host 132, the network access controller 122, and the central management controller 114 may be combined into a single appliance, or combined in various manners into two appliances.

In the restaurant chain example, in addition to including end devices 144 to monitor soap usage, the restaurants may also include other types of end devices 144, such as end devices that comprise sensors to monitor kitchen oil usage, sensors to monitor the weather outside, as well as other types of sensors. System 100 is structured to allow a user to organize the different types of end devices 144 into different application networks. Thus, each application 140 and corresponding application network may be associated with one particular type of end device 144. For example, all of the end devices 144 involved with soap monitoring may communicate with a soap monitoring application and may be part of a soap monitoring application network; all of the end devices 144 involved with monitoring kitchen oil may communicate with a kitchen oil monitoring application and may be part of a kitchen oil monitoring application network; and all of the end devices 144 involved with weather monitoring may communicate with a weather monitoring application and be part of a weather monitoring application network. Any or all of these different types of applications 140 may be running on multiple gateway hosts 132, and each gateway host 132 may run more than one type of application 140. The application networks may be monitored by a user using the central management controller 114.

In some embodiments, software containers may be used on the gateway hosts 132 to package an application 140 and dependencies together allowing ease of distribution and maintenance. A software container is a unit of software that packages up code and all its dependencies so the application runs quickly and reliably from one computing environment to another. The containers may isolate a running process from the underlying operating system, by limiting file system and device access, increasing security of the system as a whole. The containers may isolate software from its environment and ensure that it works uniformly despite differences, for instance, between development and staging.

In some LoRa® implementations, devices at a gateway type level, such as level 106, may simply receive data from end devices and then forward that data to a cloud server for processing. Thus, all received data is forwarded to the cloud, with no processing or business logic being applied to the data at the gateway level. In contrast, in one embodiment of system 100, instead of gateway hosts 132 sending every received piece of end device data all the way up to the central management controller 114, the gateway hosts 132 include built-in intelligence to process the data, and beneficially limit the amount of data that is transferred to the central management controller 114. Specifically, each gateway host 132 includes a network server 134, and an application 140 running on an application server 136, which apply logic to the raw end device data. Thus, the communications between the gateway hosts 132 and the central management controller 114 are more intelligent communications, as opposed to the gateway hosts 132 simply forwarding raw data to the controller 114. System 100 allows real-time actions to be performed on the data at the gateway level, rather than sending raw data to an application running in the cloud, processing the data in the cloud, and then waiting for a response from the cloud before performing an action. In addition, if the central management controller 114 were to temporarily go down, the gateway hosts 132 are still able to receive and process data during this time, and the system 100 can recover more quickly than a system that performs all data processing in the cloud. In other embodiments, the application servers 136 may be implemented in the cloud, or the system 100 may include application servers 136 in the gateway hosts 132 and in the cloud. The functionality of any of the applications 140 may be divided between the gateway host 132 and a cloud server, such that a first portion of the application 140 runs on the gateway host 132, and a second portion runs on the cloud server and works in conjunction with the first portion.

Returning to the soap dispenser example, an end device 144 monitoring a soap dispenser may just provide an indication to a gateway host 132 each time the dispenser lever is pressed. The application 140 receives this data, and may be configured to know how much soap is used during each press of the dispenser lever. The application 140 may then track a total amount of soap that has been used, a rate at which the soap is being used, and may track or determine other factors regarding soap usage. The application 140 may then report these results of its processing to the central management controller 114. The application 140 may or may not report the actual sensor data received from the end devices 144. Depending on how the application 140 is configured, the application 140 itself may make certain decisions and provide corresponding indications to a user, such as an indication of when a particular soap dispenser is almost empty and needs to be refilled, or the central management controller 114 may make such decisions. The application 140 may also send control signals to end devices 144 to provide a signal to a user, such as causing a light in the end device 144 to light up to indicate to a user that the soap dispenser is almost empty.

In one embodiment, the network communications in system 100 include network level traffic and application level traffic. The network level data is what is used between an end device 144 and a network server 134 to handle join requests and control network level parameters, such as communication channel, speed, frequency, as well as other parameters. The application level data includes the sensed data (e.g., sensed weather data) generated by the end devices 144 and transmitted to the gateway hosts 132. Network root keys are used to generate session keys to encrypt network level traffic, and application root keys are used to generate session keys to encrypt application level traffic. In each gateway host 132, the packet forwarder 138 forwards received data packets, including network level packets and application level packets, to the network server 134. The network server 134 processes the network level packets, and forwards the application level packets to the application server 136 for processing by the application 140. The traffic manager 124 in the network access controller 122 is in communication with the network server 134, as indicated by communication link 133. The traffic manager 124 is also in communication with the policy manager 126, and receives rules for managing network traffic from the policy manager 126. The traffic manager 124 may receive traffic rules from the policy manager 126, such as packet filtering rules, and may control the flow of network traffic based on the traffic rules. For example, the traffic manager 124 may allow only a certain subset of the gateway hosts 132 to send data to the central management controller 114.

The traffic manager 124 may also perform load balancing. In one embodiment, each end device 144 is explicitly paired with one gateway host 132. This pairing may be modified by the system 100 to facilitate load balancing. For example, assume that a particular site includes two gateway hosts 132, with a first one of the gateway hosts 132 associated with one hundred end devices 144 and a second one of the gateway hosts 132 associated with ten end devices 144. In this situation, the traffic manager 124 may reassign some of the one hundred end devices 144 associated with the first gateway host 132 to be associated instead with the second gateway host 132 to more evenly divide the total number of end devices 144 between the two gateway hosts 132.

In order for an end device 144 to participate in system 100, it goes through a join process. The end device 144 sends a join request to a gateway host 132, which forwards the request to network access controller 122. The join server 128 in the network access controller 122 receives the join request, performs an authentication process, and retrieves root keys associated with the end device 144 that sent the join request from the key store 120. The join server 128 is communicatively coupled to the key store 120 via communication link 129. The root keys may initially be programmed into each end device 144 at the time of manufacture, and then these keys may later be copied to the key store 120. The join server 128 may generate session keys based on the retrieved root keys. The session keys may be stored in the key and state cache 130. The session keys are used by the end device 144, network server 132, and application server 136 to encrypt and decrypt the communications between the end device 144 and the gateway host 132.

Some implementations of system 100 may include multiple join servers 128. In such systems, traffic manager 124 and policy manager 126 may be configured to identify an optimal one of the join servers 128 to send each join request. The identification of the optimal join server 128 for a given join request may be determined based on a variety of factors, such as the manufacturer of the end device 144 sending the join request, the locations of the end device 144 and the join servers 128, as well as other factors. The traffic manager 124 and policy manager 126 may also be configured to filter out certain join requests, such as a join request from an unknown end device 144. The abilities to filter out join requests, and direct join requests to an optimal join server, are useful because there may be a limited time window in which a join must be accomplished. If a response to a join request is not received within, for example, five seconds, the join may fail. Any failed join means that the end device 144 requesting the join is not able to transfer sensor data to the network. By having an optimal join path identified at the network access controller level 104, it is much more likely that joins will be able to be accomplished within the short time window, resulting in a high rate of successful joins.

In one embodiment, gateway hosts 132 may be configured to forward certain received join requests to a security monitoring application 150. For example, if a gateway host 132 receives a join request from an unknown end device 144, or an end device 144 that is known or suspected to be a rogue device, the gateway host 132 may reject the request to join, and forward the join request to the security monitoring application 150. By analyzing such rejected join requests, the security monitoring application 150 may then be able to identify and address security threats to the system 100. This join request information may also be useful for tracking the locations of end devices 144. For example, rejected join requests could be forwarded by the gateway hosts 132 to a tracking application 152, which could be accessed by a user to identify the location of a particular end device 144.

System 100 may also be used to multicast messages to the end devices 144. As an example, each of the end devices 144 could be a device that controls the tilt angle of a solar panel. Central management controller 114 could be used to cause a multicast message to be periodically sent to all of the end devices 144 to change the current tilt angle of the solar panels, which would allow all of the solar panels to track the movement of the sun throughout the day. Multicast messages may also be sent by the central management controller to update firmware and software of the gateway hosts 132, including the applications 140.

The central management controller 114 includes a graphical web UI 116 to allow a user to configure various aspects of the system 100, and a device management controller 118 to control the gateway hosts 132 and the end devices 144. In one embodiment, the network access controller 122 and each of the gateway hosts 132 also include a graphical web UI to allow a user to directly configure these devices. A user may remotely access the graphical web UI 116 using a computer or mobile device. In one embodiment, the graphical web UI 116 displays a home page with a list of selectable functions, including dashboard, network and application network, gateways, device and end devices, policies, operations, people, user and user's account profile, organization, support, and log out. These selectable functions are described in further detail below.

Selecting the dashboard function from the home page results in the display of a dashboard page that contains links and graphs pertaining to application networks, gateways 132, and end devices 144. Each graph may provide specific data in increments of hours, days, or weeks. The dashboard includes an application networks field, a gateways field, and an end devices field. The application networks field contains a count of application networks and a link to the application networks page. The gateways field contains a count of gateways 132 and a link to the gateways page. The end devices field contains a count of end devices 144 and a link to the end devices page.

The dashboard also includes several graphs, including a gateway map graph, a packets per hour/day/week graph, and join requests per hour/day/week graph, a cyclic redundancy check (CRC) error percentage per hour/day/week graph, and a missed packets per hour/day/week graph. The gateway map graph shows the location of each gateway host 132 that has latitude and longitude coordinates. The packets per hour/day/week graph shows the number of packets received by each gateway host 132 over time. Statistics accompanying the chart may include average number of packets per hour, day, or week, and counts of uplinks and downlinks. The data may also include details of the last packet received. The join requests per hour/day/week graph includes the number of join requests received over time. Statistics accompanying the chart may include average number of join requests per hour, day, or week, and counts of successful and failed join requests. The data may also include details of the last join request received. The CRC error percentage per hour/day/week graph includes the number of packets received with failed CRCs over time. Statistics accompanying the chart may include average number of CRC error rate per hour, day, or week. The data may also identify the gateway host 132 with the highest CRC error percentage. The missed packets per hour/day/week graph includes missed uplinks (i.e., number of uplink packets not received by the network server, and missed downlink ACKs (incremented for each confirmed uplink retry received by the network server, this indicates the number of downlink packets not received by the end device 144). Statistics accompanying the chart may include packet uplink and downlink averages per hour, day, or week, and counts of missed uplinks and downlinks.

Selecting the application networks function from the home page results in the display of an application networks page. An application network is a network of gateway hosts 132 and end devices 144 that can be connected in order to report application data from deployed sensors. From the application networks page, a user can associate end devices 144 to gateway hosts 132, and allow end devices 144 to join a gateway host 132 and report data to an application 140 on that gateway host 132. In one embodiment, if an end device 144 and a gateway host 132 do not share an application network, then the end device 144 cannot join to that gateway host 132. In one embodiment, a gateway host 132 can belong to many application networks, but an end device 144 can belong to only one application network. The application networks page displays the number of total application networks, followed by a list of the application networks. Each application network in the list includes a number of end devices 144 and gateways 132 associated with that application network. The application networks page may be used to create new application networks, edit existing application network settings, and monitor application network statuses.

The application networks page may also be used to create application network profiles, which are settings for end devices 144 to operate with. The application network profiles may be used to apply a standard configuration to multiple end devices 144. When an end device 144 first joins to the network, it receives any network profile settings via media access control (MAC) commands. Any deviation between the network profile and the default settings of the end device 144 are sent to the end device 144 in successive MAC commands until all settings have been relayed.

Selecting the gateways function from the home page results in the display of a gateways page that includes a number of total gateway hosts 132, followed by a list of gateway hosts 132. The gateways page may be used to provision a new gateway host 132, view and edit settings for a gateway host 132, and upload a data file (e.g., a comma separated values (CSV) file or another type of data file) of gateways 132. The provisioning of a new gateway host 132 involves creating a new gateway host 132 in the system 100, and assigning it to one or multiple application networks.

Selecting the policies function from the home page results in the display of a policies page. Gateway hosts 132 may receive requests from end devices 144 outside the network. To prevent these end devices 144 from sending join requests to the join server 128, policies may be established on the policies page to block unwanted traffic at the gateway hosts 132. Policies may include whitelists of end devices 144 allowed to have their join requests forwarded to the join server 128. Policies become available to a gateway host 132 when it checks in. Each gateway host 132 associated with a policy enforces the policy. End devices 144 may be added to the whitelist by selecting end device groups and/or application networks. End devices 144 may also be added to the whitelist by creating custom filters for specific device extended unique identifiers (EUIs), device EUI ranges, join EUIs, or join EUI ranges. When a policy has been set up, the policy can be applied to selected gateway hosts 132 and/or to all of the gateway hosts 132 associated with selected application networks.

Selecting the end devices function from the home page results in the display of an end devices page. Before sending data, an end device 144 must join a gateway host 132. A transmit session may last as long as the end device 144 and gateway host 132 maintain the keys and counter associated with the sessions. If either side loses session information, a new join may be performed. In one embodiment, an end device 144 can be joined to only one network server instance on a gateway host 132. In one embodiment, the end devices page displays a count of end devices 144, followed by a list of end devices 144. The end devices page may be used to provision a new end device 144, view and edit settings of end devices 144, and upload a data file (e.g., CSV file) of end devices 144.

Selecting the operations function from the home page results in the display of an operations page. This page may be used to schedule firmware upgrades (e.g., firmware over-the-air (FOTA)), and unicast or multicast messages for end devices 144. FOTA allows the gateway hosts 132 to update firmware on many end devices at once using multicast and error correction packets. Both messages and upgrades can be scheduled for individual end devices 144 and groups of end devices 144. The operations page allows a user to view information about currently scheduled messages and firmware upgrades. This page also allows a user to cancel scheduled upgrades and messages. When an upgrade is scheduled on the operations page, the gateway host 132 sends two setup downlinks to the end device firmware. The first message is a fragmentation setup request. The firmware responds by sending back a fragmentation setup answer. The gateway host 132 then sends a multicast session setup request to the firmware. The firmware responds with a multicast session setup answer. Once the setup is complete, the firmware waits the amount of time configured in the multicast setup request. At the end of the countdown, the firmware switches into Class C with the specified data rate and frequency to receive the file fragments sent by the gateway host 132. After the file fragments are sent, the gateway host 132 starts sending parity fragments. At any point when the firmware is able to reconstruct the firmware file, the CRC is calculated and the CRC message ID is sent in Class A. This could happen any time after the last fragment is sent to after the last parity is sent.

Selecting the user function from the home page results in the display of a user page. On this page, a user may access a user profile, which provides the user email, and first and last name. The user profile also includes permissions for the user, which may be “Admin” (e.g., organization super-user, which is an administrator who has full access within the organization), “Manager” (e.g., user with access to manage application networks, gateway hosts 132, and end devices 144 within the organization), and “User” (e.g., user with read-only and restricted access to data within the organization).

Selecting the organization function from the home page results in the display of an organization page, which allows users with organization administration rights to update their organization's information in the system 100.

System 100 is a scalable solution that simplifies the management of networking devices. System 100 allows operators and manufacturers to securely deploy, use, and manage end devices 144, gateway hosts 132, and network access controllers 122. System 100 provides secure key management and policy and traffic management. System 100 leverages edge computing capabilities, and enables enterprises to balance join loads on distributed Internet of Things (IoT) networks. System 100 provides a hybrid approach that combines cloud computing resources and edge computing resources, and provides intelligence at the edge. System 100 provides clear information regarding what end devices 144 are accessing the network. End devices 144 may have pre-shared keys installed and uploaded to the key store 120. This allows an end device 144 to securely join selected gateway hosts 132 without having foreknowledge of the application network. In the join process, information is exchanged between the end device 144, the gateway host 132, and the join server 128. System 100 gives enterprises control over: (1) deployment of end devices 144 and gateway hosts 132; (2) expanding and scaling network operations; (3) centralized management of network devices as a Software Defined Network (SDN); and (4) advanced security, including secure key management.

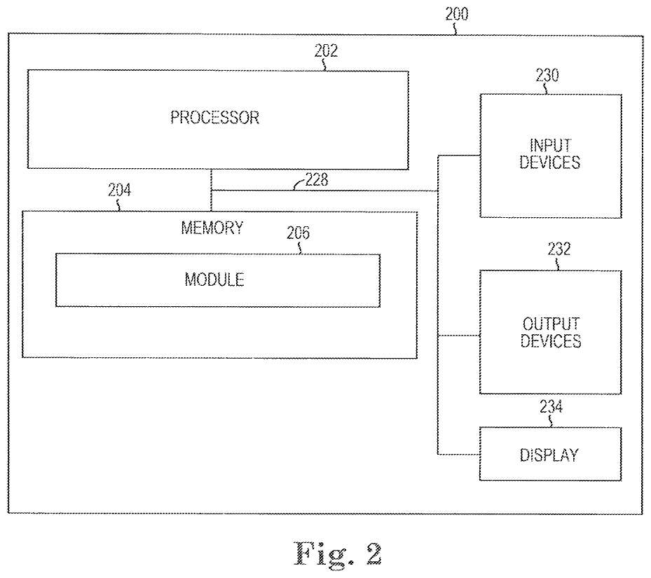

FIG. 2 is a block diagram illustrating a computing system 200 for implementing elements of the system 100 shown in FIG. 1 in accordance with one embodiment. Computing system 200 includes at least one processor 202, a memory 204, input devices 230, output devices 232, and display 234. In the illustrated example, processor 202, memory 204, input devices 230, output devices 232, and display 234 are communicatively coupled to each other through communication link 228.

Input devices 230 include a keyboard, mouse, data ports, and/or other suitable devices for inputting information into system 200. Output devices 232 include speakers, data ports, and/or other suitable devices for outputting information from system 200. Display 234 may be any type of display device that displays information to a user of computing system 200.

Processor 202 includes a central processing unit (CPU) or another suitable processor. In one example, memory 204 stores machine readable instructions executed by processor 202 for operating the system 200. Memory 204 includes any suitable combination of volatile and/or non-volatile memory, such as combinations of Random Access Memory (RAM), Read-Only Memory (ROM), flash memory, and/or other suitable memory. These are examples of non-transitory computer readable storage media. The memory 204 is non-transitory in the sense that it does not encompass a transitory signal but instead is made up of at least one memory component to store machine executable instructions for performing techniques described herein.

Memory 204 stores module 206. Processor 202 executes instructions of module 206 to perform techniques described herein. It is noted that some or all of the functionality of module 206 may be implemented using cloud computing resources.

In one embodiment, the various subcomponents or elements of the system 200 may be embodied in a plurality of different systems, where different modules may be grouped or distributed across the plurality of different systems. To achieve its desired functionality, system 200 may include various hardware components. Among these hardware components may be a number of processing devices, a number of data storage devices, a number of peripheral device adapters, and a number of network adapters. These hardware components may be interconnected through the use of a number of busses and/or network connections. The processing devices may include a hardware architecture to retrieve executable code from the data storage devices and execute the executable code. The executable code may, when executed by the processing devices, cause the processing devices to implement at least some of the functionality disclosed herein.

One embodiment of the present disclosure is directed to a LoRa® network server deployment with a hybrid distributed architecture that provides more intelligence and capabilities at the edge. Another embodiment is directed to a LoRa® network solution that allows configurable filtering at the edge to save network bandwidth and increase the overall performance of the system. Another embodiment is directed to a LoRa® network solution that dynamically performs load balancing of LoRa® sessions between different gateway hosts that are part of the network to increase the functionality and reachability of the LoRa® end devices in the network. Another embodiment is directed to appliances that comprise any part of the architecture disclosed herein to achieve the overall system solution. Another embodiment is directed to methods for capturing unwanted or unrecognized LoRa® traffic and routing that traffic to a separate server for surveillance or security analysis. Another embodiment is directed to a system that completely de-links application specific data processing from the overall LoRa® server solution. Another embodiment is directed to a system in which application data is handled by user applications installed on the gateways hosts and fully owned by the user. Another embodiment is directed to a system with the ability to scale by adding multiple units at various layers depending on the volume and complexity of the server deployment.

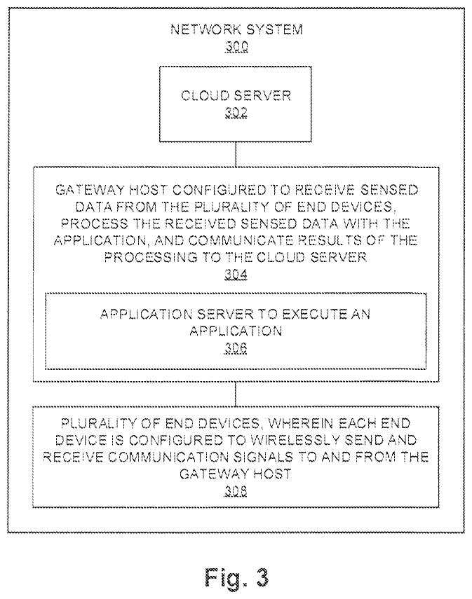

One embodiment of the present disclosure is directed to a network system. FIG. 3 is a block diagram illustrating a network system 300 in accordance with one embodiment. Network system 300 includes a cloud server 302, and a gateway host 304 coupled to the cloud server 302. The gateway host 304 includes an application server 306 to execute an application. The network system 300 also includes a plurality of end devices 308. Each end device 308 is configured to wirelessly send and receive communication signals to and from the gateway host 304. The gateway host 304 is configured to receive sensed data from the plurality of end devices 308, process the received sensed data with the application 306, and communicate results of the processing to the cloud server 302.

The network system 300 may be a low power wide area network (LPWAN) system. Each of the end devices 308 may comprise a battery-operated sensor. The gateway host 304 may reduce an amount of traffic to the cloud server 302 by communicating the results of the processing to the cloud server 302 rather than forwarding all of the sensed data to the cloud server.

The plurality of end devices 308 may include a plurality of different types of end devices, and the plurality of different types of end devices may be respectively associated with a plurality of different application networks. End devices of a same type may belong to a same one of the application networks, and end devices of different types may belong to different ones of the application networks. The application server 306 of the gateway host 304 may be configured to execute a plurality of applications, and each of the applications may be associated with a different one of the application networks.

The gateway host 304 may be configured to continue to receive and process the sensed data when a connection to the cloud server 302 is lost, and the gateway host 304 may be configured to communicate results of the processing to the cloud server 302 when the connection is reestablished.

The network system 300 may further include a plurality of gateway hosts, and a network access controller configured to receive join requests from the plurality of gateway hosts, wherein the join requests may be sent from the plurality of end devices 308 to the gateway hosts to request to participate in the network system 300. Each of the end devices 308 may be paired with one of the gateway hosts, and the network access controller may be configured to modify the pairing of the end devices to the gateway hosts to facilitate load balancing.

The network system 300 may further include a plurality of join servers to process the join requests, and the network access controller may be configured to identify, for each of the join requests, an optimal one of the gateway hosts to pair with the end device that sent the join request. The network access controller may be configured to identify an optimal one of the gateway hosts for each join request based on at least one of the following: manufacturer of the end device that sent the join request; the locations of the gateway hosts and the end device that sent the join request; and radio frequency characteristics of the end device that sent the join request.

The gateway host 304 may be configured to update firmware of multiple ones of the end devices 308 concurrently by multicasting file fragments and error correction packets to those end devices. The end devices 308 may be configured to reconstruct a firmware file from the file fragments, and calculate a cyclic redundancy code (CRC) for the reconstructed firmware file. The application server 306 of the gateway host 304 may be configured to execute a plurality of applications, each of the applications may be sandboxed in a separate software container.

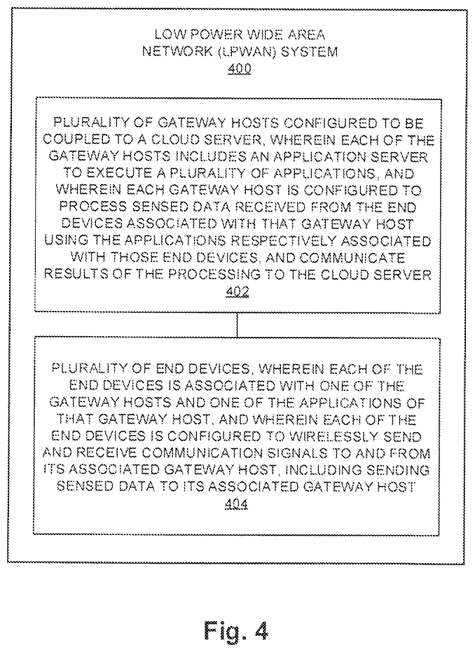

Another embodiment of the present disclosure is directed to an LPWAN system. FIG. 4 is a block diagram illustrating an LPWAN system 400 in accordance with another embodiment. LPWAN system 400 includes a plurality of gateway hosts 402 configured to be coupled to a cloud server, wherein each of the gateway hosts includes an application server to execute a plurality of applications. LPWAN system 400 also includes a plurality of end devices 404, wherein each of the end devices is associated with one of the gateway hosts and one of the applications of that gateway host, and wherein each of the end devices is configured to wirelessly send and receive communication signals to and from its associated gateway host, including sending sensed data to its associated gateway host. Each of the gateway hosts 402 is configured to process sensed data received from the end devices associated with that gateway host using the applications respectively associated with those end devices, and communicate results of the processing to the cloud server.

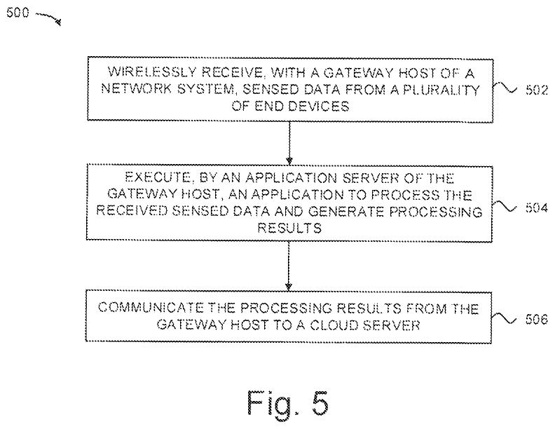

Yet another embodiment of the present disclosure is directed to a method in a network system. FIG. 5 is a flow diagram illustrating a method 500 in a network system in accordance with one embodiment. At 502, the method 500 includes wirelessly receiving, with a gateway host of a network system, sensed data from a plurality of end devices. At 504, the method 500 includes executing, by an application server of the gateway host, an application to process the received sensed data and generate processing results. At 506, the method 500 includes communicating the processing results from the gateway host to a cloud server.

The network system in method 500 may be a low power wide area network (LPWAN) system, and each of the end devices may comprise a battery-operated sensor. The plurality of end devices may include a plurality of different types of end devices, and the method 500 may further include: executing, by an application server of the gateway host, a plurality of applications to process the received sensed data and generate the processing results, wherein each of the applications is associated with and processes sensed data from end devices of only one of the types. End devices of a same type may belong to a common application network, and end devices of different types may belong to different application networks.

Although the present disclosure has been described with reference to preferred embodiments, workers skilled in the art will recognize that changes can be made in form and detail without departing from the spirit and scope of the present disclosure.

What is claimed is:

1. A network system, comprising:
a cloud server;
a gateway host coupled to the cloud server, wherein the gateway host includes an application server to execute an application;
a plurality of end devices, wherein each end device is configured to wirelessly send and receive communication signals to and from the gateway host; and
wherein the gateway host is configured to receive sensed data from the plurality of end devices, process the received sensed data with the application, and communicate results of the processing to the cloud server.

2. The network system of claim 1, wherein the network system is a low power wide area network (LPWAN) system.

3. The network system of claim 1, wherein each of the end devices comprises a battery-operated sensor.

4. The network system of claim 1, wherein the gateway host reduces an amount of traffic to the cloud server by communicating the results of the processing to the cloud server rather than forwarding all of the sensed data to the cloud server.

5. The network system of claim 1, wherein the plurality of end devices includes a plurality of different types of end devices, and wherein the plurality of different types of end devices are respectively associated with a plurality of different application networks.

6. The network system of claim 5, wherein end devices of a same type belong to a same one of the application networks, and wherein end devices of different types belong to different ones of the application networks.

7. The network system of claim 6, wherein the application server of the gateway host is configured to execute a plurality of applications, and wherein each of the applications is associated with a different one of the application networks.

8. The network system of claim 1, wherein the gateway host is configured to continue to receive and process the sensed data when a connection to the cloud server is lost, and wherein the gateway host is configured to communicate results of the processing to the cloud server when the connection is reestablished.

9. The network system of claim 1, and further comprising a plurality of gateway hosts, and a network access controller configured to receive join requests from the plurality of gateway hosts, wherein the join requests are sent from the plurality of end devices to the gateway hosts to request to participate in the network system.

10. The network system of claim 9, wherein each of the end devices is paired with one of the gateway hosts, and wherein the network access controller is configured to modify the pairing of the end devices to the gateway hosts to facilitate load balancing.

11. The network system of claim 9, and further comprising a plurality of join servers to process the join requests, and wherein the network access controller is configured to identify, for each of the join requests, an optimal one of the gateway hosts to pair with the end device that sent the join request.

12. The network system of claim 11, wherein the network access controller is configured to identify an optimal one of the gateway hosts for each join request based on at least one of the following: manufacturer of the end device that sent the join request; the locations of the gateway hosts and the end device that sent the join request; and radio frequency characteristics of the end device that sent the join request.

13. The network system of claim 1, wherein the gateway host is configured to update firmware of multiple ones of the end devices concurrently by multicasting file fragments and error correction packets to those end devices.

14. The network system of claim 13, wherein the end devices are configured to reconstruct a firmware file from the file fragments, and calculate a cyclic redundancy code (CRC) for the reconstructed firmware file.

15. The network system of claim 1, wherein the application server of the gateway host is configured to execute a plurality of applications, and wherein each of the applications is sandboxed in a separate software container.

16. A method, comprising:
wirelessly receiving, with a gateway host of a network system, sensed data from a plurality of end devices;
executing, by an application server of the gateway host, an application to process the received sensed data and generate processing results; and
communicating the processing results from the gateway host to a cloud server.

17. The method of claim 16, wherein the network system is a low power wide area network (LPWAN) system, and wherein each of the end devices comprises a battery-operated sensor.

18. The method of claim 16, wherein the plurality of end devices includes a plurality of different types of end devices, and wherein the method further includes:
executing, by an application server of the gateway host, a plurality of applications to process the received sensed data and generate the processing results, wherein each of the applications is associated with and processes sensed data from end devices of only one of the types.

19. The method of claim 18, wherein the end devices of a same type belong to a common application network, and wherein end devices of different types belong to different application networks.

20. A low power wide area network (LPWAN) system, comprising:
a plurality of gateway hosts configured to be coupled to a cloud server, wherein each of the gateway hosts includes an application server to execute a plurality of applications;
a plurality of end devices, wherein each of the end devices is associated with one of the gateway hosts and one of the applications of that gateway host, and wherein each of the end devices is configured to wirelessly send and receive communication signals to and from its associated gateway host, including sending sensed data to its associated gateway host; and
wherein each gateway host is configured to process sensed data received from the end devices associated with that gateway host using the applications respectively associated with those end devices, and communicate results of the processing to the cloud server.
